(19) United States
(12) Patent Application Publication
(10) Pub. No.: US 2008/0241697 A1
(43) Pub. Date: Oct. 2, 2008

(54) NON-AQUEOUS ELECTROLYTE BATTERY

(75) Inventor: Naoki Imachi, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/058,316

(22) Filed: Mar. 28, 2008

(30) Foreign Application Priority Data
Mar. 28, 2007 (JP) 2007-083759
Dec. 17, 2007 (JP) 2007-325300

(51) Int. Cl. H01M 2/16

(52) U.S. Cl. 429/246

(57) ABSTRACT

In a non-aqueous electrolyte battery having a positive electrode (1), a negative electrode (2), a separator (3), and a non-aqueous electrolyte, an electrolyte diffusion restricting layer (11) for restricting diffusion of the electrolyte is formed between the positive electrode (1) and the separator (3) to accelerate deterioration of the positive electrode, and an electrolyte diffusion promoting layer (21) for promoting diffusion of the electrolyte is formed between the negative electrode (2) and the separator (3) to hinder deterioration of the negative electrode.

### BACKGROUND OF THE INVENTION

1. Field of the Invention

The present invention relates to non-aqueous electrolyte batteries, such as lithium-ion batteries, and more particularly to a battery structure that is excellent in safety after cycling for a long period and is highly reliable even with a high capacity battery design.

2. Description of Related Art

Rapid advancements in size and weight reductions of mobile information terminal devices such as mobile telephones, notebook computers, and PDAs in recent years have created demands for higher capacity batteries as driving power sources for the devices. Lithium-ion batteries, which have high energy density among secondary batteries, have achieved higher capacity year by year. In particular, as mobile telephones have had increasing numbers of features, such as color display function, video function, data communication function, and music function, the power consumption has been increasing. Accordingly, there is a strong demand for a lithium-ion battery with higher capacity and higher performance.

However, the capacity that can be achieved by the lithium-ion battery seems to be approaching the limit. The capacity of lithium-ion battery has increased at an annual rate of 5% or more for over 10 years since it was first introduced into the market, already reaching higher than 2 times as high capacity as was provided at the initial stage of its commercialization. During this period, a certain degree of capacity increase has been achieved by optimizing the electrode materials and improving the battery designs. However, the performance inherent to the materials has been maximized fully, and therefore it is inevitable to rely on application technologies such as using electrodes with higher filling density and reducing thickness of the components (see, for example, Japanese Published Unexamined Patent Application No. 2002-141042). This is believed to be partly due to the fact that, although there are several candidates for active materials in next generation high capacity batteries, the lithium cobalt oxide/graphite material system, the first one that was made commercially available, has such high performance and capacity that it is difficult to find a material that is superior in overall performance to this battery system easily.

As described above, in order to achieve further higher capacity in the circumstance in which substantial capacity increase cannot be expected, it is unavoidable to rely on application technologies such as increasing the filling density of electrodes and reducing thickness of components such as the battery can, the separator, and the current collector, and as a consequence, the battery characteristics that have been maintained conventionally tend to be unbalanced. As the battery has such an increased filling density and consequently has a configuration or design that imposes very heavy burden on the materials, the deteriorations that cannot be expected from those with the conventional designs may occur. For example, unlike conventional electrodes of simple design, in which the filling density is relatively low and an environment in which the electrolyte can be diffused sufficiently is formed, the electrodes with high filling density have drawbacks such as insufficient electrolyte diffusion and non-uniformity in the electrode reactions. When battery cycling is carried out for a long period under such conditions, the non-uniform reactions proceed continuously, resulting in side reactions other than normal charge-discharge reactions, so that battery degradations such as sudden electrode deterioration and deterioration in safety tend to occur. In the currently-used lithium cobalt oxide/graphite material system, the volumetric change ratio of the graphite negative electrode is as high as about 10% while the volumetric change ratio of the lithium cobalt oxide positive electrode associated with charge and discharge is about 2%, which means that the entry and exit of the electrolyte is more violent in the negative electrode plate. This tendency is expected to be more significant with the use of alloy-based negative electrodes that are currently under research and development as a new negative electrode material.

In the conventional battery configuration, the separator has a large film thickness such that the separator can serve a buffer action against the volumetric change associated with the expansion and shrinkage of the electrodes and serve to supplement necessary electrolyte. However, as the batteries have higher capacity, the separator film thickness is inevitably reduced, and since the amount of electrode material applied is increased, the amount of the electrolyte required per unit area becomes inevitably greater. Moreover, the electrolyte that should have been supplemented conventionally is expelled to the outside of the wound electrode assembly system, so the electrolyte needs to diffuse therefrom into the interior. As this cycle is repeated, the supply of the electrolyte cannot keep pace, and the reactions tend to become non-uniform especially in the negative electrode, which undergoes greater volumetric changes. As a consequence, the performance deterioration is less in the positive electrode, which does not require such a large amount of electrolyte, while the deterioration is exacerbated in the negative electrode, which requires a larger amount of electrolyte, causing an imbalance in the capability of lithium intercalation and deintercalation between the positive and negative electrodes. This creates a condition in which the battery quality deterioration tends to be accelerated easily. (Specifically, problems arise that electrolyte dry-out occurs during charge-discharge cycles and lithium deposits on the negative electrode, causing short circuiting between the positive and negative electrodes). Such a phenomenon tends to occur in high temperature operating environments or in high voltage operating environments, in which the amount of the electrolyte consumed is greater, and how this phenomenon can be prevented is an important issue in the development of lithium-ion batteries, particularly in high capacity batteries, large-sized batteries, and high voltage batteries, which are believed to be the mainstream in the development.

Accordingly, it is an object of the present invention to provide a non-aqueous electrolyte battery that shows excellent safety even after a long period of battery cycling and exhibits high reliability even with a battery configuration featuring high capacity.

### BRIEF SUMMARY OF THE INVENTION

In order to accomplish the foregoing and other objects, the present invention provides a non-aqueous electrolyte battery comprising: a wound electrode assembly wherein a positive electrode, a negative electrode, and a separator interposed between the positive and negative electrodes are spirally wound, and a non-aqueous electrolyte impregnated in the wound electrode assembly; and an electrolyte diffusion restricting layer formed between the positive electrode and the separator, for restricting diffusion of the electrolyte, and an electrolyte diffusion promoting layer formed between the negative electrode and the separator, for promoting diffusion of the electrolyte.

### BRIEF DESCRIPTION OF THE DRAWINGS

FIG. 1 is a graph illustrating the correlation between the amounts of lithium deposited within a battery and the temperatures at which the battery starts to generate heat;

FIG. 2 is a schematic view illustrating how the electrolyte diffuses as the battery is cycled;

FIG. 3 is a schematic illustrative view illustrating how the electrolyte diffuses in the battery; and

FIG. 4 is a schematic view illustrating the electrode assembly of the non-aqueous electrolyte battery according to one embodiment of the invention.

### DETAILED DESCRIPTION OF THE INVENTION

The non-aqueous electrolyte battery according to the present invention comprises: a wound electrode assembly wherein a positive electrode, a negative electrode, and a separator interposed between the positive and negative electrodes are spirally wound, and a non-aqueous electrolyte impregnated in the wound electrode assembly; and an electrolyte diffusion restricting layer formed between the positive electrode and the separator, for restricting diffusion of the electrolyte, and an electrolyte diffusion promoting layer formed between the negative electrode and the separator, for promoting diffusion of the electrolyte.

In the present invention, the term “electrolyte diffusion restricting layer” means a layer that is capable of restricting the supply of electrolyte to the positive electrode. In the case of the battery employing a wound electrode assembly in which the positive and negative electrodes are wound with a separator, the electrolyte permeates and diffuses along a winding width direction of the wound electrode assembly to be supplied to the interiors of the positive and negative electrodes. Here, the separator has TD (transverse direction) and MD (machine direction) originating from the manufacturing process, and the winding width direction of the wound electrode assembly corresponds to the TD. In other words, the electrolyte permeates and diffuses along the TD of the separator. Therefore, when a layer that has a poorer electrolyte permeability than the electrolyte permeability of the separator along the TD is interposed between the positive electrode and the separator, the supply of the electrolyte to the positive electrode can be restricted as a result. Thus, the “electrolyte diffusion restricting layer” is, in other words, a layer that has a poorer electrolyte permeability than the electrolyte permeability of the separator along the TD.

Contrary to the foregoing, when a layer that has a better electrolyte permeability than that of the separator along the TD is provided between the negative electrode and the separator, the supply of electrolyte to the negative electrode is promoted as a result. Thus, the term “electrolyte diffusion promoting layer” means a layer capable of promoting the supply of electrolyte to the negative electrode, and in other words, it refers to a layer that has a better electrolyte permeability than the electrolyte permeability of the separator along the TD.

According to the foregoing configuration, while the deterioration of the positive electrode is made slightly hastened by providing the electrolyte diffusion restricting layer on the positive electrode side, in which the volumetric change associated with charge-discharge reactions is smaller, to restrict the diffusion of the electrolyte, the deterioration of the negative electrode can be significantly restrained by providing the electrolyte diffusion promoting layer on the negative electrode side, in which the volumetric change is greater, to make the diffusion of the electrolyte smoother. As a result, it becomes possible to make uniform the reactions of the negative electrode, which undergoes greater volumetric expansion and violent entry and exist of electrolyte. Moreover, by adjusting the balance in the deterioration between the two electrodes, the performance deterioration proceeds while the lithium intercalation-deintercalation capabilities between the positive electrode and the negative electrode are in good balance during the battery cycling. Therefore, it is possible to prevent battery quality degradation such as sudden performance deterioration and deterioration in safety even in a long-term use condition of the battery.

It is preferable that the electrolyte diffusion restricting layer be a polymer layer, and the electrolyte diffusion promoting layer be a porous layer.

When the electrolyte diffusion restricting layer is a polymer layer, it becomes possible to easily form a layer having a desired electrolyte permeability, i.e., a poorer electrolyte permeability than that of the separator along TD, in a simple manner. On the other hand, when the electrolyte diffusion promoting layer is a porous layer, it becomes possible to easily form a layer having a desired electrolyte permeability, i.e., a better electrolyte permeability than that of the separator along TD, in a simple manner; moreover, it becomes possible to control the electrolyte permeability at a desired level easily by, for example, adjusting the porosity.

It is preferable that the polymer layer comprise at least one polymer component selected from the group consisting of polyvinylidene fluoride, polyalkylene oxide, polymer compounds containing polyacrylonitrile units, and derivatives thereof.

The polyvinylidene fluoride, the polyalkylene oxide, the polymer compounds containing polyacrylonitrile units, and the derivatives thereof are excellent in oxidation resistance. Therefore, by selecting the polymer component from these substances, it becomes possible to make the electrolyte diffusion restricting layer stable in the battery.

It is preferable that the porous layer contain inorganic particles and a binder agent.

When the electrolyte diffusion promoting layer is a porous layer containing inorganic particles, it is easy to form the gap space that serves as the permeation and diffusion paths for the electrolyte. Moreover, the formation of the layer is also easy.

It is preferable that the inorganic particles comprise at least one of alumina and rutile-type titania.

The reason why the filler particles are restricted to the rutile-type titania and/or alumina as described above is that these materials show good stability within the battery (i.e., have low reactivity with lithium) and moreover they are low cost materials. The reason why the rutile-type titania is employed is as follows. The anatase-type titania is capable of insertion and deinsertion of lithium ions, and therefore it can absorb lithium and exhibit electron conductivity, depending on the surrounding atmosphere and or the potential, so there is a risk of capacity degradation and short circuiting.

However, in addition to the above-mentioned substances, zirconia, magnesia, and the like may also be used as the filler particles since the type of the filler particles has very small impact on the advantageous effects of the invention.

It is preferable that the binder agent used for the porous layer employs a different solvent system from a solvent system of a binder agent used for the negative electrode.

When the binder agent contained in the porous layer employs a different solvent system from that of the binder agent used for the negative electrode, the damages to the negative electrode caused by the binder agent contained in the porous layer is alleviated significantly especially when the porous layer is formed on the negative electrode surface.

It is preferable that the electrolyte diffusion promoting layer be a porous layer made of a resin-based material comprising at least one substance selected from the group consisting of polyamide, polyimide, and polyamideimide.

When the electrolyte diffusion promoting layer is a porous layer made of a resin-based material comprising at least one substance selected from the group consisting of polyamide, polyimide, and polyamideimide, it is easy to form the gap space that serves as the permeation and diffusion paths for the electrolyte. Moreover, polyamide, polyamideimide, and polyimide are excellent in mechanical strength and thermal stability and therefore capable of forming a porous layer that is not easily altered in the battery.

It is desirable that the electrolyte diffusion restricting layer have a thickness of from 0.1 μm to 1 μm.

When the thickness of the electrolyte diffusion restricting layer is 0.1 μm or greater, it is within the range in which formation of the electrolyte diffusion restricting layer is technically easily feasible. On the other hand, when the thickness of the electrolyte diffusion restricting layer is 1 μm or less, the resistance of the electrolyte diffusion restricting layer can be within the permissible range, and moreover, the electrolyte diffusion restricting layer may be such a thin film that it does not inhibit the battery from achieving a high capacity.

It is desirable that the electrolyte diffusion promoting layer have a thickness of from 1 μm to 3 μm.

When the thickness of the electrolyte diffusion promoting layer is 1 μm or greater, it is easy to form the electrolyte diffusion promoting layer uniformly. On the other hand, When the thickness of the electrolyte diffusion promoting layer is 3 μm or less, the electrolyte diffusion promoting layer may be such a thin film that it does not inhibit the battery from achieving a high capacity.

The electrolyte diffusion promoting layer that is a porous layer containing inorganic particles as described above can be formed by, for example, mixing the inorganic particles, a binder agent, and a solvent together to prepare a slurry and then applying the resultant slurry onto a surface of the negative electrode. In this case, it is desirable that when the concentration of the inorganic particles with respect to the slurry is from 1 mass % to 15 mass %, the concentration of the binder agent with respect to the inorganic particles be controlled to be from 10 mass % to 30 mass %. It is also desirable that when the concentration of the inorganic particles with respect to the slurry exceeds 15 mass %, the concentration of the binder agent with respect to the inorganic particles be controlled to be from 1 mass % to 10 mass %.

The reason why the upper limit of the concentration of the binder agent with respect to the inorganic particles is determined as described above is that if the concentration of the binder agent is too high, the mobility of lithium ions to the active material layer becomes extremely poor (i.e., the diffusion of the electrolyte is inhibited) and the resistance between the electrodes increases, resulting in a poor charge-discharge capacity. On the other hand, the reason why the lower limit of the concentration of the binder agent with respect to the inorganic particles is determined as described above is that if the amount of the binder agent is too small, the amount of the binder agent that can function between the inorganic particles themselves and between the inorganic particles and the negative electrode is too small, which may lead to peeling of the electrolyte diffusion promoting layer.

The upper limit values and the lower limit values of the concentration of the binder agent with respect to the inorganic particles are set different depending on the concentrations of the inorganic particles with respect to the slurry because, even in the case that the concentration of the binder agent with respect to the inorganic particles is the same, the concentration of the binder agent in the slurry per unit volume is higher when the concentration of the inorganic particles with respect to the slurry is high than when the just-mentioned concentration is low.

In addition, the electrolyte diffusion restricting layer and the electrolyte diffusion promoting layer may be provided, for example, separately from the positive and negative electrodes and the separator and interposed between the separator and the positive and negative electrodes. However, by providing these layers on the surfaces of the positive and negative electrodes or on the surface of the separator, the positioning alignment of the electrolyte diffusion restricting layer or the electrolyte diffusion promoting layer with the positive and negative electrodes or with the separator becomes unnecessary in the assembling step of the battery, making it possible to increase the productivity of the battery.

In this case, the electrolyte diffusion restricting layer and the electrolyte diffusion promoting layer may be formed either on the surfaces of the negative electrode surface or on the separator surface. Specifically, the following four different ways are possible. (1) The electrolyte diffusion restricting layer is formed on the positive electrode surface, while the electrolyte diffusion promoting layer is formed on the negative electrode surface. (2) The electrolyte diffusion restricting layer is formed on a surface of the positive electrode, while the electrolyte diffusion promoting layer is formed on a surface of a negative electrode side of the separator. (3) The electrolyte diffusion restricting layer is formed on a surface of a positive electrode side of the separator, while the electrolyte diffusion promoting layer is formed on a surface of the negative electrode. (4) The electrolyte diffusion restricting layer is formed on a surface of a positive electrode side of the separator, while the electrolyte diffusion promoting layer is formed on a surface of a negative electrode side of the separator.

When the electrolyte diffusion restricting layer is formed on the positive electrode surface as in the foregoing (1) or (2), the reaction between the electrode and the electrolyte is more effectively hindered, and the consumption of the electrolyte due to, for example, oxidative decomposition is lessened. Moreover, by confining the electrolyte within the electrode, deterioration of the positive electrode can be accelerated. In particular, it is desirable that the positive electrode surface be completely coated with an electrolyte diffusion restricting layer made of a gelled electrolyte.

When the electrolyte diffusion restricting layer is formed on the surface of the positive electrode side of the separator as in the foregoing (3) or (4), it is relatively easy to form the electrolyte diffusion restricting layer because the separator surface is more uniform than the positive electrode surface, so it is more preferable from the viewpoint of manufacturing. More specifically, it is difficult to form the electrolyte diffusion restricting layer on the positive electrode surface uniformly from a material in liquid form by coating or the like because of the surface irregularities and in terms of permeation to the interior of the electrode plate. Also, since the electrode is blank coated (patterned), it is desirable to form the electrolyte diffusion restricting layer also by pattern coating in order to prevent the energy density from degrading, but the layer formation is difficult to carry out by pattern coating. In addition, in the case that the electrolyte diffusion restricting layer is made of a gelled polymer, for example, most of the gelled polymer uses organic solvent systems while the positive electrode generally employs polyvinylidene fluoride (PVdF) using N-methyl-2-pyrrolidone (NMP) as the binder agent. Therefore, when the solvent-based polymer is coated onto the positive electrode surface, there is a risk of causing damages to the electrode plate substrate material. Here, although it may seem possible to avoid the problem of causing damages to the electrode plate substrate material by using a gelled polymer employing a water-based solvent, the water-based gelled polymer material shows poor affinity with the electrolyte and less swelling or the like and is also disadvantageous in ensuring ordinary battery performance; therefore, the gelled polymer employing an organic solvent system is more practical. Taking these points into consideration, it is desirable to form the electrolyte diffusion restricting layer on a surface of the separator.

When the electrolyte diffusion promoting layer is formed on the negative electrode surface as in the foregoing (1) or (3), the electrolyte can be supplied from the electrolyte diffusion promoting layer to the negative electrode without producing any loss because no blank is formed between the electrolyte diffusion promoting layer and the negative electrode surface. Moreover, coating of a slurry containing a solid substance is advantageous in that the layer formation is relatively easy when coating the negative electrode surface since the amount of binder agent contained is also small. Moreover, while the positive electrode generally employs an organic solvent-based binder agent, the negative electrode employs a binder agent comprising styrene-butadiene rubber (SBR) using an aqueous solvent, so the binder agent used for the surface thereof may be selected from a wide range of organic solvent-based binder agents. This is very advantageous in that the coating can be done while minimizing damages to the electrode plate substrate material.

In particular, as described in the above (3), it is desirable from the viewpoint of manufacturing that the electrolyte diffusion restricting layer be formed on a surface of the separator and the electrolyte diffusion promoting layer be formed on a surface of the negative electrode. On the positive electrode side, it is preferable from the viewpoint of manufacturing that the electrolyte diffusion restricting layer be formed on a surface of the separator, but in that case, it is desirable from the viewpoint of manufacturing to provide the electrolyte diffusion promoting layer on the negative electrode surface rather than forming the electrolyte diffusion promoting layer on the surface of the other side of the separator (i.e., providing the electrolyte diffusion restricting layer and the electrolyte diffusion promoting layer on respective obverse and reverse sides of the separator) because the layer formation is easier that way.

According to the present invention, while the deterioration of the positive electrode is made slightly hastened by providing the electrolyte diffusion restricting layer on the positive electrode side, in which the volumetric change associated with charge-discharge reactions is smaller, to restrict the diffusion of the electrolyte, the deterioration of the negative electrode can be significantly restrained by providing the electrolyte diffusion promoting layer on the negative electrode side, in which the volumetric change is greater, to make the diffusion of the electrolyte smoother. As a result, it becomes possible to make uniform the reactions of the negative electrode, which undergoes greater volumetric expansion and violent entry and exist of electrolyte. Moreover, by adjusting the balance in the deterioration between the two electrodes, the performance deterioration proceeds while the lithium intercalation-deintercalation capabilities between the positive electrode and the negative electrode are in good balance during the battery cycling. Therefore, it is possible to prevent battery quality degradation such as sudden performance deterioration and deterioration in safety even in a long-term use condition of the battery.

Thus, the present invention makes available a non-aqueous electrolyte battery that shows excellent safety even after a long period of battery cycling and exhibits high reliability even with a battery configuration featuring high capacity.

### PREFERRED EMBODIMENTS OF THE INVENTION

Hereinbelow, the present invention is described in further detail based on certain embodiments and examples thereof. It should be construed, however, that the present invention is not limited to the following embodiments and examples, but various changes and modifications are possible without departing from the scope of the invention.

### Preparation of Positive Electrode

A positive electrode was prepared as follows. Lithium cobalt oxide (containing 1.0 mol % of Al and 1.0 mol % of Mg in the form of solid solution and 0.05 mol % of Zr electrically in contact with the surface) as a positive electrode active material, acetylene black as a carbon conductive agent, and PVdF as a binder were mixed together at a mass ratio of 95:2.5:2.5 and agitated with NMP as a diluting solvent, using a Combi Mix mixer made by Primix Corp., to thus prepare a positive electrode mixture slurry. This was coated onto both sides of an aluminum foil serving as a positive electrode current collector, and then dried and pressure-rolled to form an electrode plate. The filling density of the positive electrode was 3.7 g/cc.

Preparation of Positive Electrode Provided with Polymer Layer

2 mass % of PVdF was dissolved into dimethyl carbonate (DMC) to prepare a slurry for coating the positive electrode, and the resultant slurry was coated onto the positive electrode by dip coating. The resultant material was dried, and thus a polymer coated positive electrode was obtained. The thickness of PVdF coated on the positive electrode surface was 0.5 μm.

### Preparation of Negative Electrode

A negative electrode was prepared as follows. A carbon material (graphite) serving as a negative electrode active material, carboxymethylcellulose sodium (CMC), and styrene-butadiene rubber (SBR) were mixed together in an aqueous solution at a mass ratio of 98:1:1 and then coated onto both sides of a copper foil. Thereafter, the resultant material was dried and pressure rolled to form an electrode plate. The filling density of the negative electrode was 1.60 g/cc.

Preparation of Negative Electrode Provided with Porous Layer

Titanium oxide (KR380 made by Titanium Kogyo Co., Ltd.) and PVdF as a binder (the proportion to the titanium oxide was 5 mass %) were mix together and diluted with NMP so that the solid content became 30 mass %, and subjected to a agitating and dispersing treatment using a Filmics mixer made by Primix Corp. to prepare a slurry for coating the negative electrode. The resultant slurry was coated onto the negative electrode surface at a predetermined thickness by gravure coating. The resultant material was dried, and thus a negative electrode on which a porous layer was coated was prepared. The thickness of the titanium oxide layer prepared on the negative electrode surface was 2 μm.

### Preparation of Non-Aqueous Electrolyte

LiPF₆ was dissolved at a concentration of 1.0 mol/L in a mixed solvent of 3:7 volume ratio of ethylene carbonate (EC) and diethyl carbonate (DEC) to prepare an electrolyte.

### Construction of Battery

A battery was constructed as follows. Respective lead terminals were attached to the positive and negative electrodes, and the positive and negative electrodes were wound in a spiral form with a separator (made of polyethylene, film thickness 16 μm, porosity 47%) interposed therebetween. The wound electrodes were then pressed into a flat shape to prepare an electrode assembly, and the prepared electrode assembly was inserted into a battery case made of aluminum laminate, followed by filling the electrolyte into the battery case and sealing it, to thus prepare a battery. The design capacity of this battery was 780 mAh, and the battery was designed to have an end-of-charge voltage of 4.2 V. The battery was also designed such that the capacity ratio between the positive and negative electrodes (the initial charge capacity of the negative electrode/the initial charge capacity of the positive electrode) was 1.08 at a potential of 4.2 V.

### EXAMPLES

### Preliminary Experiment

It has been observed conventionally that in most cases, the batteries that have undergone cycle life deterioration are in such conditions as follows. The electrolyte has dried out mainly in the negative electrode. This causes non-uniform charge-discharge reactions, and an increase of the internal resistance of the negative electrode additionally also occurs, making the lithium ions that migrate from the positive electrode toward the negative electrode difficult to be absorbed in the negative electrode. When the battery is allowed to deteriorate to the extreme condition in a cycle test, lithium that cannot be absorbed in the electrode may deposit on the negative electrode surface, and depending on the amount and form of the deposition, it is possible that the battery that has undergone the deterioration may pose safety hazards.

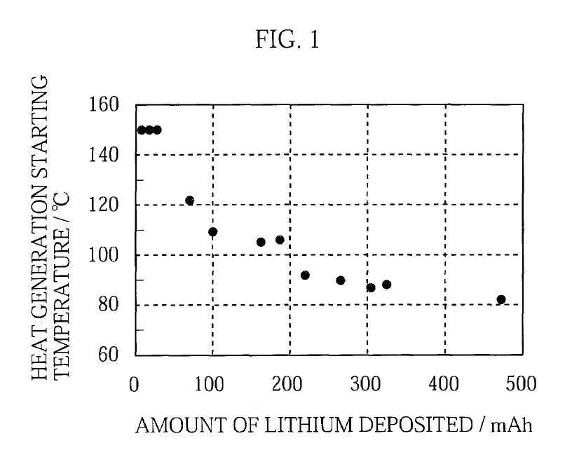

For the purpose of simulating this situation, the following experiment was conducted. A battery was fabricated in the same manner as described in the foregoing preferred embodiment except that the surfaces of the positive electrode and the negative electrode were not subjected to the coating treatments. The resultant battery was set aside at −5° C. for a long period of time to intentionally lower the lithium ion accepting capability of the negative electrode active material, and then charged. The amount of lithium deposited on the negative electrode surface was controlled by the amount of charge. Then, the battery was put back to room temperature and then discharged after a sufficient length of time elapsed. The amount of lithium deposited was calculated from the difference between the charge capacity at the low temperature condition and the discharge capacity at room temperature. The battery was heated to 150° C. at a temperature elevation rate of 5° C./min. to confirm the heat generation behavior of the battery. The results are shown in FIG. 1.

It was demonstrated that as the amount of lithium deposited increased, the heat generation starting temperature of the battery gradually became close to 80° C. At a temperature of 80° C., metallic lithium and DEC causes heat generation. Therefore, it is believed that depending on the amounts of these substances, the heat generation starting temperature of the battery varies. Thus, when the lithium ion acceptability of the negative electrode significantly degrades due to the cycle life deterioration, it is possible that the safety of the battery lowers. It should be noted that normally the negative electrode in a discharge state does not show a heat generation behavior due to the reactions with the electrolyte up to 150° C.

### Preconditions for Battery Construction (Behavior of Electrolyte)

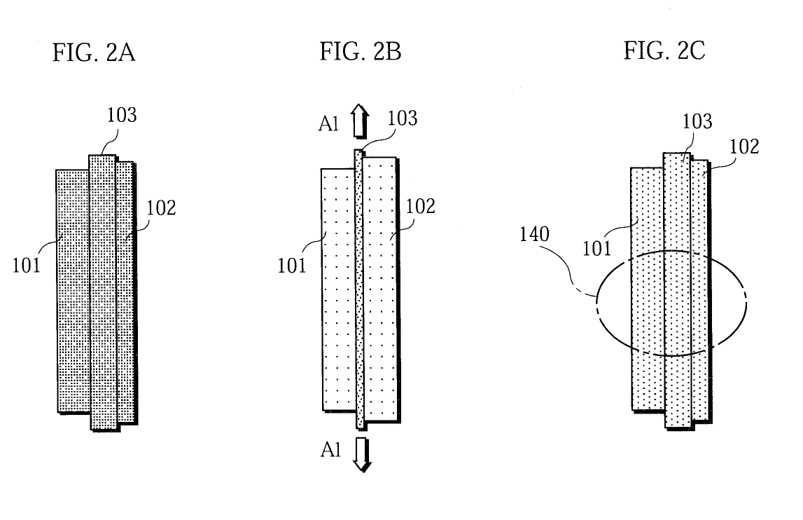

The diffusion of the electrolyte in the wound electrode assembly is discussed with reference to FIG. 2. At the initial stage of the battery assembling shown in FIG. 2(a), permeation of the electrolyte into the positive electrode 101 and the negative electrode 102 is forcibly ensured by manipulations such as decompression and pressurization. After the stages shown in FIG. 2(b) or 2(c) where the battery can has been sealed, however, such manipulations cannot be done and therefore it is necessary to employ battery components and designs such that the electrolyte can diffuse autonomously. In the cases of loose battery designs in which, for example, the electrodes have a low filling density or the separator film thickness is sufficiently thick relative to the electrode thickness, the electrolyte can migrate within the wound electrode assembly sufficiently. However, in the cases of severe battery design, the separator 103 shrinks because of the expansion of the positive electrode 101 and the negative electrode 102 that is associated with charge and discharge, so the electrolyte within the positive electrode 101 and the negative electrode 102 is squeezed out of the wound assembly as indicated the arrows A1 in FIG. 2(b). Then, when the positive electrode 101 and the negative electrode 102 shrink due to discharge as shown in FIG. 2(c), the electrolyte within the positive electrode 101 and the negative electrode 102 is gradually lost mainly in a central portion 140 as the battery cycling proceeds, unless the electrolyte is supplied again from the outside of the wound assembly, leading to dry-out of the electrolyte in the end. This is believed to be a cause of sudden capacity deterioration associated with battery cycling. In order to prevent such a situation, it is necessary to create the condition in which the electrolyte can be supplied again easily with the construction of the wound assembly of the battery. It also should be noted that, of the positive electrode 101 and the negative electrode 102, the negative electrode active material undergoes greater expansion than the positive electrode active material. Therefore, the entry and exit of the electrolyte is most significant in the negative electrode 102, so the negative electrode 102 is most susceptible to the electrolyte shortage. In this respect, it is preferable to employ a battery construction such that the supply of the electrolyte to the negative electrode 102 can be promoted.

It should be noted that the electrolyte supplied to the positive electrode 101 and the negative electrode 102 is divided into that consumed in the positive electrode 101 (oxidative decomposition), that permeates into the positive electrode 101, and that permeates into the negative electrode 102. The ratio of the distributions of the electrolyte is not clear, but the migration of the electrolyte through the separator 103 is not very smooth even when the separator 103 is porous (polyethylene does not show very high affinity with the electrolyte). Therefore, it also is believed desirable to provide a configuration such as to promote diffusion of the electrolyte to the electrode surfaces to which the electrolyte is desired to be supplied.

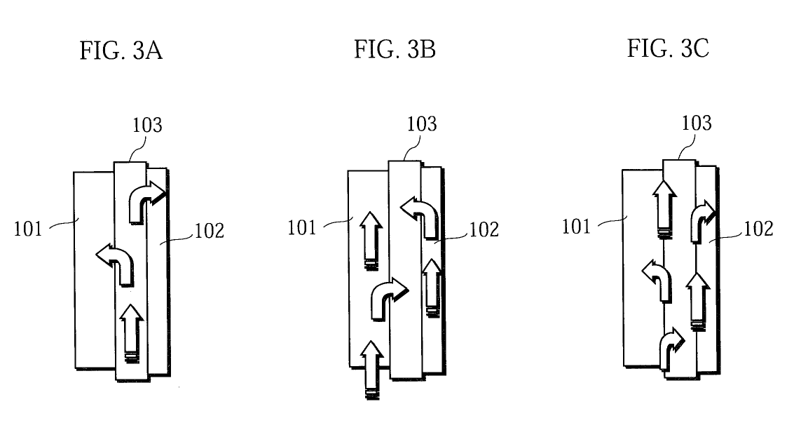

A study was conducted on the diffusion of the electrolyte in a battery construction with high capacity electrodes. As a result, its was found that the electrolyte neither diffuses through the interior of the separator 103 as shown in FIG. 3(a) nor diffuses through the interiors of the electrodes 101 and 102 as shown in FIG. 3(b), and that the electrolyte diffuses through the gaps between the interfaces of these components, as shown in FIG. 3(c). These gaps have tended to be almost lost because of a pressing process during formation of the wound assembly in the case of prismatic batteries and due to the increased winding tension in the case of cylindrical batteries. Moreover, the surfaces of the electrodes 101 and 102 are relatively made flat and smooth (particularly the graphite negative electrode 102 is compressed to a degree such that a specular surface is obtained) due to the necessity of increased filling density in the electrodes 101 and 102, so the space for the gaps has been almost lost. Thus, the current battery construction is such that the electrolyte does not easily permeate into the wound electrode assembly unless an external pressure is applied. In addition, as has been described previously, there are TD (transverse direction) and MD (machine direction) in the separator, and the cross section of the separator along the TD, which corresponds to the vertical direction of the wound electrode assembly, has less pores. Therefore, the TD is not suitable for diffusion of the electrolyte. The MD is the direction in which the polyethylene fibers extend, so the diffusion of the electrolyte is promoted along the MD to a certain degree. However, since the MD does not correspond to the vertical direction of the wound assembly, significant diffusion of the electrolyte cannot be expected. It is believed that the cycle life deterioration occurs due to combinations of these factors.

### EXAMPLES

### Example 1

A battery prepared in the same manner described in the above-described preferred embodiment was used for Example 1.

The battery obtained in this manner is hereinafter referred to as Battery A1 of the invention.

### Example 2

A battery was obtained in the same manner as described in Example 1, except that a 2 μm-thick porous layer was formed on the surface of the negative electrode side of the separator using the same slurry as the slurry for coating the negative electrode, and that no coating treatment (formation of the porous layer) was performed for the negative electrode surface.

The battery obtained in this manner is hereinafter referred to as Battery A2 of the invention.

### Example 3

A battery was obtained in the same manner as described in Example 1, except that a polymer compound containing polyacrylonitrile units (PAN) was used in place of PVdF when preparing the slurry for coating the positive electrode side, that cyclohexanone was used as the diluting solvent, and that PAN was used as the binder when preparing the slurry for coating the negative electrode side.

The battery obtained in this manner is hereinafter referred to as Battery A3 of the invention.

### Example 4

A battery was obtained in the same manner as described in Example 1, except that the battery design was such that the end-of-charge voltage was 4.4 V.

The battery obtained in this manner is hereinafter referred to as Battery A4 of the invention.

### Example 5

A battery was obtained in the same manner as described in Example 2, except that the battery design was such that the end-of-charge voltage was 4.4 V.

The battery obtained in this manner is hereinafter referred to as Battery A5 of the invention.

### Comparative Example 1

A battery was obtained in the same manner as described in Example 1, except that no coating treatment was performed for the surfaces of the positive electrode and the negative electrode.

The battery obtained in this manner is hereinafter referred to as Comparative Battery Z1.

### Comparative Example 2

A battery was obtained in the same manner as described in Example 1, except that no coating treatment was performed for the surface of the negative electrode.

The battery obtained in this manner is hereinafter referred to as Comparative Battery Z2.

### Comparative Example 3

A battery was obtained in the same manner as described in Example 1, except that no coating treatment was performed for the surface of the positive electrode.

The battery obtained in this manner is hereinafter referred to as Comparative Battery Z3.

### Comparative Example 4

A battery was obtained in the same manner as described in Example 5, except that no coating treatment was performed for the surfaces of the positive electrode and the negative electrode.

The battery obtained in this manner is hereinafter referred to as Comparative Battery Z4.

### Comparative Example 5

A battery was obtained in the same manner as described in Example 5, except that no coating treatment was performed for the surface of the negative electrode.

The battery obtained in this manner is hereinafter referred to as Comparative Battery Z5.

### Comparative Example 6

A battery was obtained in the same manner as described in Example 5, except that no coating treatment was performed for the surface of the positive electrode.

The battery obtained in this manner is hereinafter referred to as Comparative Battery Z6.

Test Results for the Design with an End-of-Charge Voltage of 4.2 V

Batteries A1 to A3 of the invention and Comparative Batteries Z1 to Z3, which were designed to have an end-of-charge voltage of 4.2 V, were subjected to a cycle test and a subsequent thermal test. The capacity retention ratios and the conditions of the negative electrode surfaces observed by the cycle test, and the results of the thermal test after the cycle test are shown in Table 1 below.

The cycle test and the thermal test were conducted in the following manner.

Charge Test

Each of the batteries was charged at a constant current of 1 It (750 mA) to 4.20 V and further charged at a constant voltage of 4.20 V to a current of 1/20 It (37.5 mA).

Discharge Test

Each of the batteries was discharged at a constant current of 1 It (750 mA) to 2.75 V.

Interval

The interval between the charge test and the discharge test was 10 minutes. Cycle Test at 60° C.

According to the above-described charge-discharge conditions, the 1 It charge-discharge cycle was performed in an atmosphere at 60° C.—

Thermal Test (Safety Test After the Cycle Test)

The batteries that showed a capacity retention ratio of 50% or lower in the cycle test were disassembled to investigate the condition of the remaining electrolyte in the negative electrodes. In addition, the same types of the batteries were subjected to the cycle test and then brought to a discharged state, then heated from 25° C. to 150° C. at a temperature elevation rate of 2° C./min. in a thermostatic chamber, to investigate the heat generation starting temperature of each of the batteries.

TABLE 1

| | Layer between positive electrode and separator | | | Layer between negative electrode and separator | | | | End-of- | Number of |
|---|---|---|---|---|---|---|---|---|---|
| | | Type of | | | Type of | | | charge | cycles when |
| | Location of | polymer | Thickness | Location of | inorganic | Type of | Thickness | voltage | remaining |
| Battery | Polymer layer | layer | (μm) | porous layer | particles | binder | (μm) | (V) | capacity is 50% |
| A1 | Positive electrode | PVDF | 0.5 | Negative | Titanium | PVDF | 2.0 | 4.2 | 710 |
| | surface | | | electrode | oxide | | | | |
| | | | | surface | | | | | |
| A2 | | | | Separator | | | | | 630 |
| | | | | surface | | | | | |
| A3 | | PAN | | Negative | | PAN | | | 780 |
| | | | | electrode | | | | | |
| | | | | surface | | | | | |
| Z1 | — | — | — | — | — | — | — | | 360 |
| Z2 | Positive electrode | PVDF | 0.5 | — | — | — | — | | 370 |
| | surface | | | | | | | | |
| Z3 | — | — | — | Negative | Titanium | PVDF | 2.0 | | 510 |
| | | | | electrode | oxide | | | | |
| | | | | surface | | | | | |

| | | Heat generation starting temper- | Sudden capacity deteriora- |
|---|---|---|---|
| Battery | Condition of negative electrode surface after cycle test | ature of battery after cycle test | tion due to battery cycling |
| A1 | Electrolyte remained | Not observed up to 150° C. | No |
| A2 | Electrolyte remained | Not observed up to 150° C. | No |
| A3 | Electrolyte remained | Not observed up to 150° C. | No |
| Z1 | Electrolyte dried out over the entire negative electrode | 108° C. | Yes |
| Z2 | Electrolyte dried out over the entire negative electrode | 111° C. | Yes |
| Z3 | Electrolyte remained partially in the negative electrode | 136° C. | Yes |

PVDF represents polyvinylidene fluoride
PAN represents a polymer compound containing polyacrylonitrile units

As clearly seen from Table 1, the ordinary battery construction (Comparative Battery Z1) showed a gradual capacity decrease as the cycle is repeated, and a sudden capacity degradation after the 350th cycle. The reason is believed to be as follows. Since the test was conducted at 60° C., consumption of the electrolyte was accelerated because of oxidative decomposition of the electrolyte on the positive electrode surface. In addition, as shown previously, the supply of the electrolyte to the negative electrode could not keep pace so the charge-discharge reactions on the negative electrode surface became non-uniform. Actually, when the battery was disassembled, the electrolyte dried out over the entire negative electrode surface, and the electrolyte shortage was especially noticeable at the central portion of the electrode. Furthermore, the deposits such as the decomposition product of the electrolyte were found in some places. This is believed to be the reason why the heat generation starting temperature of the battery was low 108° C. after the cycle performance test.

In the case that a porous layer for promoting the supply of the electrolyte was formed on the negative electrode surface (Comparative Battery Z3), the cycle life was longer and such deterioration behaviors were alleviated. However, it was demonstrated that when the amount of the electrolyte in the battery eventually became insufficient, the battery showed a similar behavior to Comparative Battery Z1 above. In the system in which polymer coating was applied to the positive electrode to control the consumption of the electrolyte and the electrolyte distribution to the positive electrode (Comparative Battery Z2), although the cycle life had been expected to improve by hindering the consumption of the electrolyte, the supply of the electrolyte to the negative electrode could not keep pace as in the case of Comparative Battery Z1, and as a result, the safety of the battery after the deterioration was not as good as was expected.

In contrast, in the cases of Batteries A1 to A3 of the invention, the cycle life improved significantly (all of them showed a cycle life of 630 cycles or more). Moreover, they did not show the cycle life deterioration as was observed with Comparative Batteries Z1 to Z3, and the capacity monotonously decreased to 50%. The reason is believed to be as follows. Because of the polymer coating on the positive electrode, the supply of the electrolyte leaned toward the negative electrode, and the consumption of the electrolyte in the positive electrode surface due to the oxidative decomposition was reduced. Moreover, because of the porous layer on the negative electrode surface, the speed of supply of the electrolyte from the outside of the wound electrode assembly system to the interior of the electrode was increased, and the electrolyte was supplied preferentially to the negative electrode. Therefore, the balance in deterioration was kept between the positive electrode and the negative electrode, and well-balanced capacity degradation occurred since the positive electrode as well as the negative electrode underwent deterioration at the same time. In addition, it was observed that the heat generation starting temperature of the batteries after the cycle performance test was as high as 150° C.

It should be noted that the polymer coating on the positive electrode surface serves to control the reactions with the electrolyte to reduce the consumption of the electrolyte due to oxidative decomposition or the like by applying polymer capping on the positive electrode surface, in which the amount of the electrolyte entering and exiting is inherently not very great. In addition, it also serves to accelerate the deterioration of the positive electrode by confining the electrolyte within the electrode. It is believed that the configuration in which the electrolyte is supplied preferentially to the negative electrode has been established by reducing the distribution of the electrolyte to the positive electrode. It should be noted, however, that the cycle performance cannot be improved by the polymer coating on the positive electrode alone (see the test results for Comparative Battery Z2), and the cycle performance can be significantly improved by additionally employing the inorganic particle layer between the negative electrode and the separator.

Test Results for the Design with an End-of-Charge Voltage of 4.4 V

Batteries A4 and A5 of the invention and Comparative Batteries Z4 to Z6, which were designed to have an end-of-charge voltage of 4.4 V, were subjected to a cycle test and a subsequent thermal test. The capacity retention ratios and the conditions of the negative electrode surfaces observed by the cycle test, and the results of the thermal test after the cycle test are shown in Table 2 below. The test conditions were the same as in the case of Batteries A1 to A3 of the invention and Comparative Batteries Z1 to Z3, which were designed to have an end-of-charge voltage of 4.2 V, except that the batteries were charged at a constant current of 1 It (750 mA) to 4.40 V and charged at a constant voltage of 4.40 V to a current of 1/20 It (37.5 mA) in the charge test, and that the cycle test was conducted with 1 It charge-discharge cycles in the atmosphere at 45° C.

TABLE 2

| | Layer between positive electrode and separator | | | Layer between negative electrode and separator | | | | End-of- | Number of |
|---|---|---|---|---|---|---|---|---|---|
| | | Type of | | | Type of | | | charge | cycles when |
| | Location of | polymer | Thickness | Location of | inorganic | Type of | Thickness | voltage | remaining |
| Battery | Polymer layer | layer | (μm) | porous layer | particles | binder | (μm) | (V) | capacity is 50% |
| A4 | Positive electrode | PVDF | 0.5 | Negative | Titanium | PVDF | 2.0 | 4.4 | 480 |
| | surface | | | electrode | oxide | | | | |
| | | | | surface | | | | | |
| A5 | | | | Separator | | | | | 510 |
| | | | | surface | | | | | |
| Z4 | — | — | — | — | — | — | — | | 210 |
| Z5 | Positive electrode | PVDF | 0.5 | — | — | — | — | | 205 |
| | surface | | | | | | | | |
| Z6 | — | — | — | Negative | Titanium | PVDF | 2.0 | | 380 |
| | | | | electrode | oxide | | | | |
| | | | | surface | | | | | |

| | | Heat generation starting temper- | Sudden capacity deteriora- |
|---|---|---|---|
| Battery | Condition of negative electrode surface after cycle test | ature of battery after cycle test | tion due to battery cycling |
| A4 | Electrolyte remained | Not observed up to 150° C. | No |
| A5 | Electrolyte remained | Not observed up to 150° C. | No |
| Z4 | Electrolyte dried out in the central portion of the | 111° C. | Yes |
| | negative electrode | | |
| Z5 | Electrolyte dried out over the entire negative electrode | 108° C. | Yes |
| Z6 | Electrolyte dried out partially in the negative electrode | 131° C. | Yes |

PVDF represents polyvinylidene fluoride
PAN represents a polymer compound containing polyacrylonitrile units

In the case of the batteries designed for an end-of-charge voltage of 4.4 V, the following were demonstrated. The consumption of the electrolyte and the ratio of electrolyte distribution between the positive and negative electrodes changed, and as a result, some differences were observed in the degree of deterioration. However, the results were substantially the same as in the case of the batteries designed for an end-of-charge voltage of 4.2 V. Specifically, Batteries A4 and A5 of the invention exhibited improved cycle performance. Moreover, they showed a heat generation starting temperature of 150° C. after the cycle performance test, and the batteries after the deterioration showed a high level of safety as was expected initially. However, decomposition of the electrolyte is accelerated and the consumption of the electrolyte is promoted in the higher voltage battery system. Therefore, in the higher voltage battery system, the behavior of the cycle life deterioration is more noticeable even at a relatively low temperature. Generally, it is commonplace that a battery is guaranteed to have a cycle life of about 500 cycles at room temperature, but even taking into consideration the fact that the deterioration is promoted at higher temperatures, a sudden capacity degradation before reaching about 300 cycles is undesirable. Taking these things into consideration, it is believed that the configuration of the present invention is more advantageous in a high voltage battery system.

### CONCLUSION

From the foregoing results, it is demonstrated that when an electrolyte diffusion restricting layer is formed between the positive electrode and the separator and an electrolyte diffusion promoting layer is formed between the negative electrode and the separator, the supply of electrolyte within the electrodes can be distributed in a desirable manner, so that the cycle performance can be improved, and moreover, the battery safety can be ensured even when the cycle life deterioration has occurred.

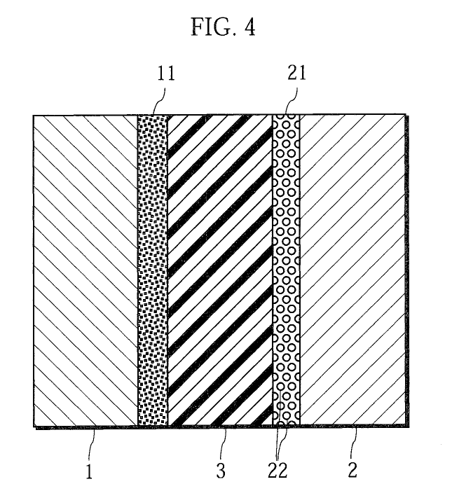

Specifically, as schematically illustrated in FIG. 4, Batteries A1 to A5 of the invention have the following configuration; in a non-aqueous electrolyte battery having a positive electrode 1, a negative electrode 2, a separator 3, and a non-aqueous electrolyte (not shown), an electrolyte diffusion restricting layer 11 for restricting diffusion of the electrolyte is formed between the positive electrode 1 and the separator 3, and an electrolyte diffusion promoting layer 21 for promoting diffusion of the electrolyte is formed between the negative electrode 2 and the separator 3. By employing such a configuration, it is made possible to slightly accelerate the deterioration of the positive electrode 1 by disposing the electrolyte diffusion restricting layer 11 on the positive electrode 1 side, which undergoes a smaller volumetric change in association with the charge-discharge reactions, to restrict the diffusion of the electrolyte, and on the other hand, it is made possible to hinder the deterioration of the negative electrode 2 significantly by disposing the electrolyte diffusion promoting layer 21 on the negative electrode 2 side, which undergoes a greater volumetric change, to make the diffusion of the electrolyte more smooth. As a result, it becomes possible to make uniform the reactions of the negative electrode, which undergoes greater volumetric expansion and violent entry and exist of electrolyte. Moreover, by adjusting the balance in the deterioration between the two electrodes 1 and 2, the performance deterioration proceeds while the lithium intercalation-deintercalation capabilities between the positive electrode 1 and the negative electrode 2 are in good balance during the battery cycling. Therefore, it is possible to prevent battery quality degradation such as sudden performance deterioration and deterioration in safety even in a long-term use condition of the battery.

Furthermore, in the cases of Batteries A1 to A5 of the invention, the electrolyte diffusion restricting layer 11 is a layer made of a polymer component. Therefore, a layer having a desired electrolyte permeability, i.e., a poorer electrolyte permeability than that of the separator 3 along TD, is easily formed in a simple manner. On the other hand, the electrolyte diffusion promoting layer 21 is a porous layer. Therefore, a layer having a desired electrolyte permeability, i.e., a better electrolyte permeability than that of the separator 3 along TD, is easily formed in a simple manner, and moreover, the electrolyte permeability is controlled at a desired level easily.

Furthermore, the electrolyte diffusion restricting layer 11 shows good stability in the battery because, in Batteries A1, A2, A4, and A5 of the invention, the polymer component is polyvinylidene fluoride, which shows excellent oxidation resistance, and in Battery A3 of the invention, the polymer component is a polymer compound containing polyacrylonitrile units.

In addition, in Batteries A1 to A5 of the invention, the thickness of the electrolyte diffusion restricting layer 11 was set at 0.5 μm. Therefore, the electrolyte diffusion restricting layer 11 can be formed technically easily, and moreover, it is made into a thin film that has a resistance within the permissible range and does not inhibit the battery from achieving a high capacity.

Also, in Batteries A1 to A5 of the invention, the thickness of the electrolyte diffusion promoting layer 21 was set at 2 μm. Therefore, the electrolyte diffusion promoting layer 21 can be formed easily uniformly, and moreover, it is made into a thin film such that it does not inhibit the battery from achieving a high capacity.

Furthermore, in the cases of Batteries A1 to A5 of the invention, the electrolyte diffusion promoting layer 21 is a porous layer containing inorganic particles 22. Therefore, it is easy to form the gap space that serves as the permeation and diffusion paths for the electrolyte, and moreover, the formation of the layer is also easy.

In the cases of Batteries A1 to A5 of the invention, the electrolyte diffusion promoting layer 21, which is a porous layer containing the inorganic particles 22, is formed by preparing a slurry by mixing the inorganic particles 22, a binder agent, and a solvent and then applying the resultant slurry onto the surface of the negative electrode 2. The concentration of the inorganic particles 22 with respect to the slurry is set at 30 mass %, while the concentration of the binder agent with respect to the inorganic particles 22 is set at 5 mass %, so the concentration of the binder agent is not excessively large. Therefore, good mobility of lithium ions to the active material layer is maintained, and the diffusion of the electrolyte is kept in a good condition. Moreover, the deterioration of the charge-discharge capacity due to the resistance between the electrodes is also inhibited. On the other hand, the amount of the binder agent that can function between the inorganic particles 22 and between the inorganic particles 22 and the negative electrode 2 is not excessively small. Therefore, the peeling of the electrolyte diffusion promoting layer 21 does not occur easily.

In addition, in the cases of Batteries A1 to A5 of the invention, the inorganic particles 22 contained in the porous layer are composed of rutile-type titania, which is excellent in mechanical strength and thermal stability. Therefore, the inorganic particles 22 are not easily altered in quality in the battery, so they are suitable as the inorganic particles 22 contained in the porous layer.

Furthermore, in Batteries A1, A3, and A4 of the invention, in which the porous layer is formed on the surface of the negative electrode 2, the binder agent contained in the porous layer employs a different solvent system from that employed in the binder agent used for the negative electrode 2. Therefore, damages to the negative electrode 2 that are caused by the binder agent contained in the porous layer are alleviated significantly.

In addition, in the cases of Batteries A1 to A5 of the invention, the electrolyte diffusion restricting layer 11 is formed on the surface of the positive electrode 1. Therefore, the reaction between the electrode and the electrolyte is more effectively hindered, and the consumption of the electrolyte due to, for example, the oxidative decomposition is reduced further. Moreover, they have a configuration such that deterioration of the positive electrode 1 can be accelerated by confining the electrolyte within the electrode.

Moreover, in the cases of Batteries A1, A3, and A4 of the invention, the electrolyte diffusion promoting layer 21 is formed on the surface of the negative electrode 2. Therefore, no blank is formed between the electrolyte diffusion promoting layer 21 and the surface of the negative electrode 2, so they have a configuration such that the electrolyte can be supplied from the electrolyte diffusion promoting layer 21 to the negative electrode 2 without producing any loss. Moreover, a slurry containing a solid substance is coated, and the amount of binder agent contained is also small. Therefore, the layer formation is relatively easy when coating the negative electrode surface. Furthermore, while the positive electrode employs an organic solvent-based binder agent, the negative electrode employs a binder agent comprising styrene-butadiene rubber (SBR) using an aqueous solvent. Therefore, although an organic solvent-based binder agent is selected as the binder agent used for coating the surface thereof, the coating process can be done while minimizing damages to the electrode plate substrate material.

In addition, in the cases of Batteries A2 and A5 of the invention, the electrolyte diffusion promoting layer 21 is formed on the surface of the separator 3. Therefore, the electrolyte diffusion promoting layer 21 is easily formed because the surface of the separator 3 is made into a uniform surface.

### OTHER EMBODIMENTS

(1) The positive electrode active material is not limited to lithium cobalt oxide. Other usable materials include lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as spinel-type lithium manganese oxides. It should be noted, however, that if a specially made positive electrode active material, such as that in which Al, Mg, and Zr are added as described above, is not used when evaluating a battery designed for a high voltage, the advantage of the present battery construction may not be confirmed because the inherent performance degradation (material deterioration) is so large that it may be difficult to fabricate a battery that can be properly evaluated, and it is undesirable to select a simple lithium cobalt oxide for the positive electrode active material.

(2) The negative electrode active material is not limited to the foregoing graphite. Various other materials may be employed, such as coke, tin oxides, metallic lithium, silicon, and mixtures thereof, as long as the material is capable of intercalating and deintercalating lithium ions.

(3) The solvent of the polymer for coating the positive electrode is not particularly limited. However, it is undesirable that the positive electrode active material layer dissolves therein. For this reason, it is desirable to use a highly volatile solvent, or it is desirable to adopt a suitable coating method, that is, a method that can perform coating at a relatively high concentration and causes little damage to the positive electrode active material layer, such as gravure coating.

(4) The electrolyte is not limited to that shown in the examples above, and various other substances may be used. Examples of the lithium salt include LiBF₄, LiPF₆, LiN(SO₂CF₃)₂, LiN(SO₂C₂F₅)₂, and LiPF_{6-X}(CₙF₂ₙ₊₁)ₓ (wherein 1<x<6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte. The types of the solvents are not particularly limited to EC and DEC mentioned above, and examples of the preferable solvents include carbonate solvents such as propylene carbonate (PC), γ-butyrolactone (GBL), ethyl methyl carbonate (EMC), and dimethyl carbonate (DMC). More preferable is a combination of a cyclic carbonate and a chain carbonate.

(5) A preferable method of polymer capping to the positive electrode surface is a method in which polymer is disposed on the surface of the positive electrode side of the separator. In this case, it is more desirable that after contacting the positive electrode, the polymer is adhered to the positive electrode surface utilizing cationic polymerization or the like, whereby the positive electrode surface is completely covered.

(6) Generally, it is not necessary that the porous layer is formed on an electrode surface as long as the condition in which the electrolyte can be supplied to the negative electrode is formed. No significant difference was observed even when the porous layer was formed on the surface of the negative electrode side of the separator (Battery A2 of the invention). Nevertheless, it is believed that when considered in more detail, forming the porous layer on the negative electrode surface (Batteries A1, A3, and A4 of the invention) is more desirable because no blank is formed between the porous layer and the negative electrode surface so the electrolyte can be supplied from the porous layer to the negative electrode without causing any loss. Further, no special physical properties are required for the polymer component and the binder component as long as they are stable to a degree that the decomposition due to the potential does not occur within the battery. On the other hand, as for the porous layer formed between the negative electrode and the separator, it is preferable that the dispersion capability of the slurry be ensured from the viewpoint of manufacturing. In that sense, it is desirable that the polymer component be a polymer compound containing polyacrylonitrile units, which is suitable for dispersing a small particle size filler.

In addition, in the step of forming a coating layer on the surface of the negative electrode active material layer, in the case that the coating layer is formed by preparing a slurry from a mixture of filler particles, a binder, and a solvent and coating the resultant slurry onto the surface of the negative electrode active material layer, it is desirable to control the concentration of the binder with respect to the filler particles to be in the range of from 1 mass % to 10 mass %, when the concentration of the filler particles with respect to the slurry exceeds 15 mass %.

Such an upper limit of the concentration of the binder with respect to the filler particles is determined for the same reason as described above. On the other hand, the lower limit of the concentration of the binder with respect to the filler particles is determined for the following reason. If the amount of binder is too small, the network made of the filler particles and the binder cannot be formed easily in the coating layer, so the trapping effect of the coating layer is lessened. In addition, the amount of the binder that can function between the filler particles and between the filler particles and the positive electrode active material layer will be too small, so peeling of the coating layer may occur.

The present invention is suitable for driving power sources for mobile information terminals such as mobile telephones, notebook computers, and PDAs, especially for use in applications that require a high capacity. The invention is also expected to be used for high power applications that require continuous operations under high temperature conditions, such as HEVs and power tools, in which the battery operates under severe operating environments.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

What is claimed is:

1. A non-aqueous electrolyte battery comprising:
a wound electrode assembly wherein a positive electrode, a negative electrode, and a separator interposed between the positive and negative electrodes are spirally wound, and a non-aqueous electrolyte impregnated in the wound electrode assembly; and
an electrolyte diffusion restricting layer formed between the positive electrode and the separator, for restricting diffusion of the electrolyte, and an electrolyte diffusion promoting layer formed between the negative electrode and the separator, for promoting diffusion of the electrolyte.

2. The non-aqueous electrolyte battery according to claim 1, wherein the electrolyte diffusion restricting layer is a polymer layer, and the electrolyte diffusion promoting layer is a porous layer.

3. The non-aqueous electrolyte battery according to claim 2, wherein the polymer layer comprises at least one polymer component selected from the group consisting of polyvinylidene fluoride, polyalkylene oxide, polymer compounds containing polyacrylonitrile units, and derivatives thereof.

4. The non-aqueous electrolyte battery according to claim 2, wherein the porous layer contains inorganic particles and a binder agent.

5. The non-aqueous electrolyte battery according to claim 3, wherein the porous layer contains inorganic particles and a binder agent.

6. The non-aqueous electrolyte battery according to claim 4, wherein the inorganic particles comprises at least one selected from the group consisting of alumina and rutile-type titania.

7. The non-aqueous electrolyte battery according to claim 5, wherein the inorganic particles comprises at least one selected from the group consisting of alumina and rutile-type titania.

8. The non-aqueous electrolyte battery according to claim 4, wherein the binder agent used for the porous layer employs a different solvent system from a solvent system of a binder agent used for the negative electrode.

9. The non-aqueous electrolyte battery according to claim 5, wherein the binder agent used for the porous layer is made from a different solvent system from a solvent system of a binder agent used for the negative electrode.

10. The non-aqueous electrolyte battery according to claim 6, wherein the binder agent used for the porous layer is made from a different solvent system from a solvent system of a binder agent used for the negative electrode.

11. The non-aqueous electrolyte battery according to claim 7, wherein the binder agent used for the porous layer is made from a different solvent system from a solvent system of a binder agent used for the negative electrode.

12. The non-aqueous electrolyte battery according to claim 1, wherein the electrolyte diffusion promoting layer is a porous layer made of a resin-based material comprising at least one substance selected from the group consisting of polyamide, polyimide, and polyamideimide.

13. The non-aqueous electrolyte battery according to claim 2, wherein the electrolyte diffusion promoting layer is a porous layer made of a resin-based material comprising at least one substance selected from the group consisting of polyamide, polyimide, and polyamideimide.

14. The non-aqueous electrolyte battery according to claim 3, wherein the electrolyte diffusion promoting layer is a porous layer made of a resin-based material comprising at least one substance selected from the group consisting of polyamide, polyimide, and polyamideimide.

15. The non-aqueous electrolyte battery according to claim 1, wherein the electrolyte diffusion restricting layer has a thickness of from 0.1 μm to 1 μm.

16. The non-aqueous electrolyte battery according to claim 1, wherein the electrolyte diffusion promoting layer has a thickness of from 1 μm to 3 μm.

17. The non-aqueous electrolyte battery according to claim 1, wherein the electrolyte diffusion restricting layer is formed on a surface of the positive electrode, and the electrolyte diffusion promoting layer is formed on a surface of the negative electrode.

18. The non-aqueous electrolyte battery according to claim 1, wherein the electrolyte diffusion restricting layer is formed on a surface of the positive electrode, and the electrolyte diffusion promoting layer is formed on a surface of a negative electrode side of the separator.

19. The non-aqueous electrolyte battery according to claim 1, wherein the electrolyte diffusion restricting layer is formed on a surface of a positive electrode side of the separator, and the electrolyte diffusion promoting layer is formed on a surface of the negative electrode.

20. The non-aqueous electrolyte battery according to claim 1, wherein the electrolyte diffusion restricting layer is formed on a surface of a positive electrode side of the separator, and the electrolyte diffusion promoting layer is formed on a surface of a negative electrode side of the separator.
